(19) United States
(12) Patent Application Publication
(10) Pub. No.: US 2005/0132340 A1
(43) Pub. Date: Jun. 16, 2005

(54) System and method for selection of translation routine for versioned data

(75) Inventors: Jon Michael Houghton, Raleigh, NC (US); Billy Ray Rowe JR., Apex, NC (US); Edward Charles Satler, Cary, NC (US)

Correspondence Address: VAN LEEUWEN & VAN LEEUWEN, P.O. BOX 90609, AUSTIN, TX, 78709-0609, US

(73) Assignee: International Business Machines Corporation, Armonk, NY (US)

(21) Appl. No.: 10/736,299

(22) Filed: Dec. 15, 2003

(51) Int. Cl. G06F 9/45

(52) U.S. Cl. 717/136

(57) ABSTRACT

A system and method for selection of versioned translation routine is presented. A component sends a translation request to a translator service whereby the translation request includes provided input version, a requested output version, and a provided input data value. The translator service compares the provided input version and the requested output version with registered input versions and registered output versions of a plurality of translators. The translation service selects one or more translators based upon a hierarchical comparison approach, and translates the provided input data value into a translated data value. After translation, the translator service sends the translated data value to the component.

### BACKGROUND OF THE INVENTION

1. Technical Field

The present invention relates in general to a system and method for selection of translation routines for versioned data. More particularly, the present invention relates to a system and method for selecting a translator to translate data based upon a provided input type and version, and a requested output type and version corresponding to a translation request.

2. Description of the Related Art

Many computer systems today use a component-based architecture for their programming system, such as Java 2 Enterprise Edition (J2EE), Web Services, and Net. Component-based architectures include a multitude of components that request information from each other and pass information to each other. Components may indirectly launch other components in situations where a first component requests information from a second component. For example, a first component wishes to request functionality from a second component but the first component includes data in XML whereas the second component accepts data in the form of XSD. In this example, the two components' data may reference the same semantic object (in different formats) but they are unable to communicate until a translation bridge is provided from XML to XSD for the specific semantic object.

Over time as such component-based systems grow with additional components from different application families or business domains, the likelihood of data impedance mismatches grows dramatically. This makes it exceedingly difficult to create new solutions based on the existing components simply due to the data impedance mismatches. This is true even if the data to be exchanged between two components refers to the same or similar entities, but the data format is different.

A challenge found in component-based architectures is that “data impedance mismatches” occur when the data value format of a requesting component is different than an input data format requirement of a recipient component even if the semantics of both is the same. Component mismatches occur particularly when components are contributed and/or registered to a system from “program families” in different problem space domains over time, such as with the case of many client server platforms (e.g. Java 2 Enterprise Edition).

In addition, software and data modules are frequently versioned to facilitate upgrades in the field at the component level. This may result in a software component-based system which has components and data at multiple version levels. This presents a unique problem in translators that accept versioned data as input, and translate it into a format which requires a particular version. A challenge found is managing versions, both on what a translator receives as well as what the translator provides.

What is needed, therefore, is a system and method for selecting a translator to translate data based upon the input data's type and version and the requested output type and version.

### SUMMARY

It has been discovered that the aforementioned challenges are resolved by comparing a translator's input type and version with an input data's type and version along with comparing the translator's output type and version with a requested data type and version output in order to identify an acceptable translator to translate the data. The translation service uses a hierarchical selection criteria table to build a translation list that includes translator identifiers whose corresponding translators meet a particular selection criteria.

A first component wishes to send a call to a second component. The first component looks-up the second component's input requirements from the second component's declaration in a component storage area. The input to the component is defined in terms of properties. Each property includes two attributes which are a “type” and a “version”. The combination of type and version is called a “property type.” In essence, this provides for extending the typing system with the inclusion of version information. The first component determines that it requires a translator service to translate data into a format corresponding to the second component's input property's type and version.

The first component generates a translation request and sends the translation request to a translator service. The translation request includes an input property type, an output property type, provided input data, and whether the component accepts a near compliant translation. The input property type describes a “type” and “version” corresponding to the provided input data. The output property type describes a “type” and “version” of the translated data which the first component wishes to receive from the translator service.

The translator service receives the translation request and creates a list of translators that have a declared input data type that matches the declared input data type in the translation request as well as the translator having a declared output data type that matches the output data type in the translation request. From this list, the translation service identifies one or more translators based upon a translator's input version and output version.

The translator service uses various levels of selection criteria in order to rank acceptable translators. The translator service first identifies translators whose input version matches the provided input version and whose output version matches the requested output version. For each identified translator, the translator service includes a corresponding identifier in a translation list. The translator service proceeds to identify other acceptable translators by using comparisons that are not exact version matches. The translator service compares a translator's input version to the provided input version and compares the translator's output version to the requested output version, building a priority ordered translator list. For each identified translator, the translator service adds a corresponding translator identifier to the translator list in a tiered order.

Once the translator service is finished building the translation list, the translator service selects the first translator identifier in the translation list since the list is built in order of priority. The translation service translates the provided input data into a translated data value using the corresponding translator. The translator service then returns the translated data to the first component. The first component is now able to generate a call to a second component using the translated data value.

Other approaches may be used to invoke the second component with translated data. One such approach uses a mediator (intermediary) to invoke the second component. In such cases, the mediator provides the translation either directly or indirectly by using a translation service. Another approach would have the first component internally provide the translation service by building the translator list itself and making direct requests to translators. In one embodiment, a translator service may use the invention described herein solely for data migration purposes to translate a data's version without translating the data's type.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing a component requesting a translator service to translate data from one property type to a different property type;

FIG. 2A is a diagram showing a server processing a client request and the server using a mediator to translate a data value received from a first component to send to a second component;

FIG. 2B is a diagram showing a first component identifying a translator, translating a request using the translator, and calling a second component using the translated request;

FIG. 3A is a structural representation of a translation request;

FIG. 3B is a translator look-up table that includes translators with various property types and property versions;

FIG. 4 is a user interface window that includes various XML declarative statements;

FIG. 5 is a flowchart showing steps taken in selecting a translator and using the translator to translate a component request;

FIG. 6 is a flowchart showing steps taken in generating a translator list using a provided input version and requested output version that correspond to a translation request;

FIG. 7 is a translation selection criteria table showing an order at which a translation service selects translators based upon input and output data versions; and

FIG. 8 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

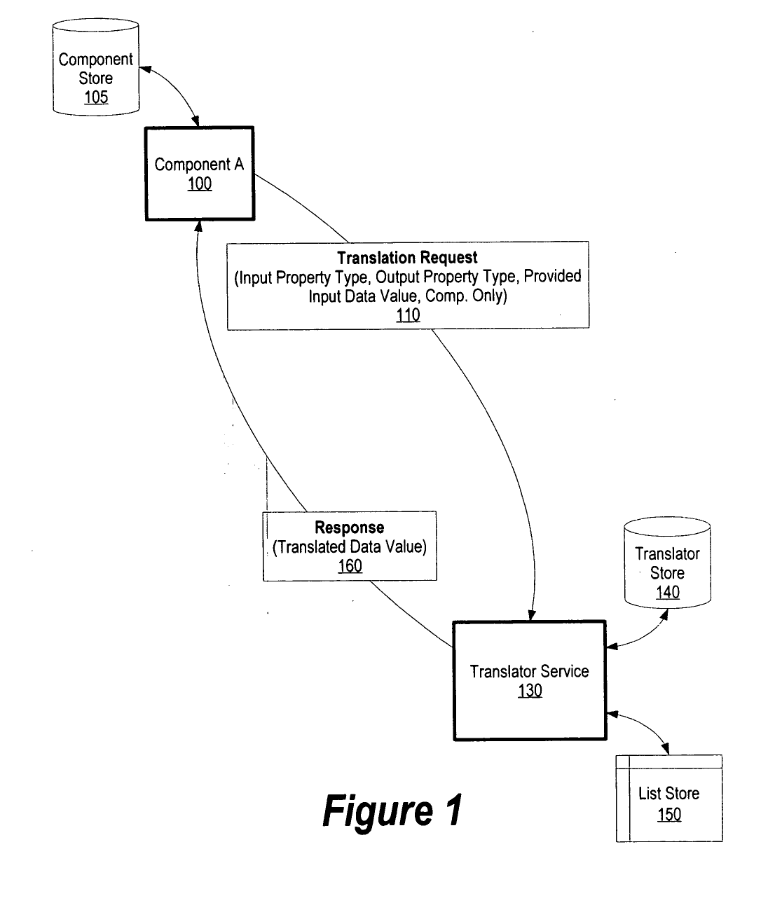

FIG. 1 is a diagram showing a component requesting a translator service to translate data from one property type to a different property type. Component A 100 wishes to send a call to a second component and looks-up the second component's input property type in component store 105. Each property type includes two attributes which are a “type” and a “version.” Component A 100 determines that it requires data to be translated prior to sending the data to the second component. Component store 105 may be stored on a nonvolatile storage area, such as a computer hard drive.

Component A 100 generates a translation request 110 and places the translation request on a function call to the translator service 130. Translation request 110 includes an “input property type” that corresponds to “provided input data value” that is also included in translation request 110. The “provided input data value” is the data that the translator service 130 translates. The “input property type” includes two attributes which are a “type” and “version”. The “version” identifies the version of the input data.

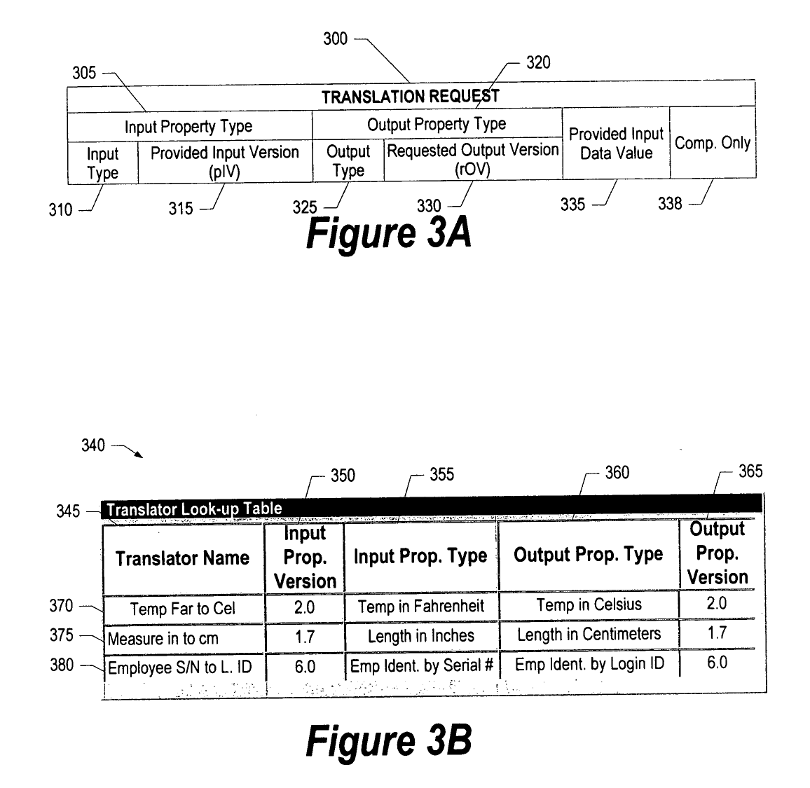

Translation request 110 also includes an output property type that has two attributes which are a “type” and a “version”. The output “type” informs translator service 130 as to which type to translate the input data and the output “version” informs translator service 130 as to which version of the “type” to translate the “provided input data value.” Translation request 110 also includes a “Compliant only” value which informs translator service 130 whether it should only return translations that are version compliant. This value can additionally indicate that the translator may relax its versioning restrictions because the requesting component is able to use earlier versions of the requested output data that are considered close or near to the requested version (see FIG. 3A and corresponding text for further details regarding translation request attributes). The output property type corresponds to the second component's requirement to receive input data.

Translator service 130 receives translation request 110 and identifies one or more translators located in translator store 140 whose input and output “types” match that in the request. This forms the master list from which all other search criteria is applied in locating appropriate translators. From these translators it identifies those whose input version (IV) correlates to the provided input version (pIV) and whose output version (OV) correlates to the requested output version (rOV). Translator service 130 uses various levels of selection criteria in order to rank acceptable translators.

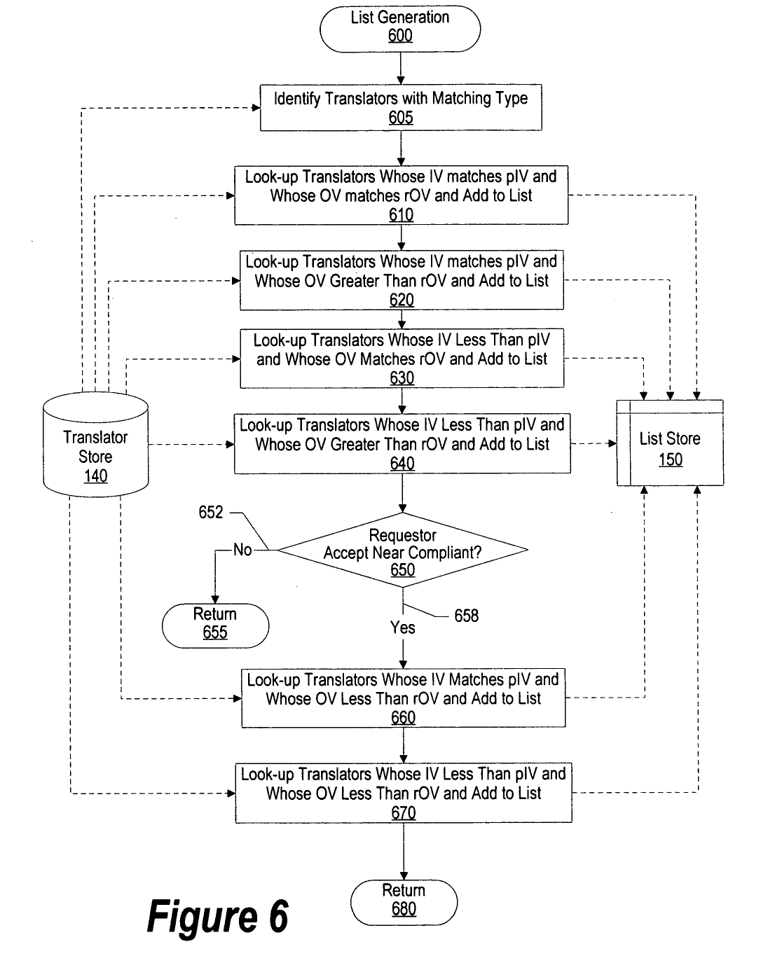

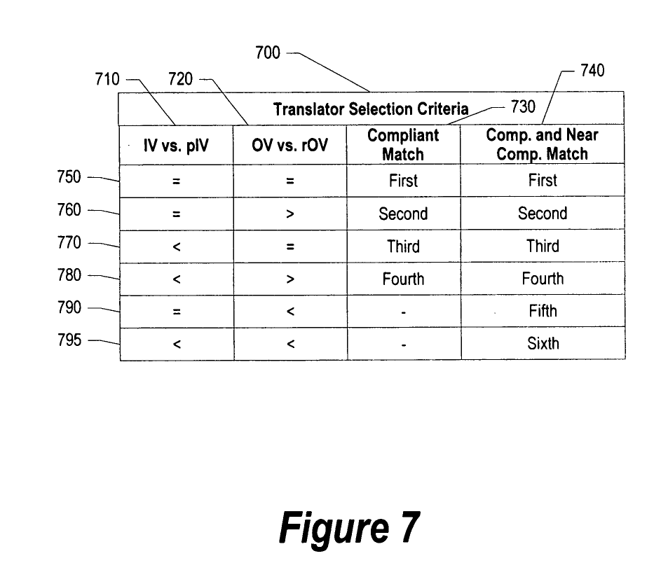

Translator service 130 first identifies translators whose input version (IV) matches the provided input version (pIV) and whose output version (OV) matches the requested output version (rOV). Translator service 130 proceeds to identify other acceptable translators from the master list by comparing a translator's input version (IV) with the provided input version (pIV) and comparing the translator's output version (OV) with the requested output version (rOV). For each identified translator, translator service 130 adds a corresponding translator identifier in a translator list located in list store 150 in a particular order based upon how closely each translator's input and output version compares with translation request 110's provided input version and requested output version (see FIGS. 6, 7, and corresponding text for further details regarding translator selection criteria). List store 150 may be stored on a volatile storage area, such as volatile memory.

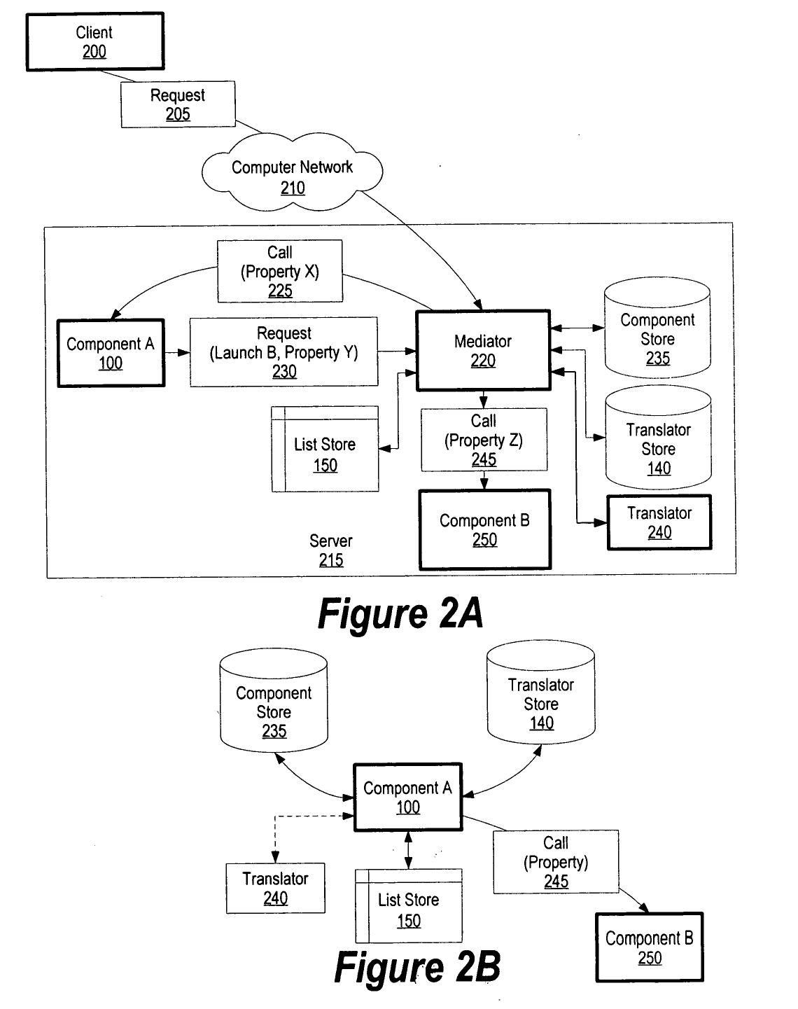

Once translator service 130 is finished building the translation list, translator service 130 selects the first translator identifier in the translation list, and translates the provided input data value into a translated data value using the corresponding translator. If the translation is successful, translator service 130 includes the translated data value in response 160, and sends response 160 to component A 100. Component A 100 is now able to generate a call to a second component using the translated data value. Other approaches may be used to translate a component request, such as using a mediator or having a component translate a data value itself (see FIGS. 2A, 2B and corresponding text for further details regarding other translation approaches).

FIG. 2A is a diagram showing a server processing a client request and the server using a mediator to translate a data value received from a first component to send to a second component. Client 200 sends request 205 to server 215 through computer network 210, such as the Internet. Server 215 receives request 205 and invokes mediator 220 to process the request. Mediator 220 determines that component A 100 should be invoked, and sends call 225 to component A 100 which includes property X. Property X includes various attributes in which component A 100 uses. Component A 100 is the same as that shown in FIG. 1

During the execution of call 225, component A 100 determines that component B 250 should be invoked. Component A 100 (i.e. the requesting component) sends request 230 to mediator 220. Request 230 includes a launch target identifier (i.e. “Launch B”) and a property (i.e. “Property Y”). The launch target identifier and the property, coupled with an input specification of component B 250, enables mediator 220 to identify a translator in translator store 140. Translator store 140 is the same as that shown in FIG. 1.

Mediator 220 extracts an input property type from request 230 that corresponds to a provided input data value which is also included in request 230. The provided input data value is the data that mediator 220 translates. The input property type includes two attributes which are a “type” and a “version.” The “version” identifies the version of the provided input data value, and the “type” identifies the type of the provided input data value.

Mediator 220 extracts the launch target identifier (i.e. “Launch B”) to identify a recipient component located in component store 235. The declaration of component B includes information about the input property of component B, which includes its type and its version. Component store 235 may be stored on a non-volatile storage area, such as a computer hard drive.

Mediator 220 compares the data provided by Component A 100 and the input property of Component B 250 and determines that data translation is necessary. Mediator first builds a type list, and then performs a version comparison using the type list. Mediator 220 selects a translator, such as translator 240, based upon how translator 240's input version (IV) compares to the provided input version (pIV) and how its output version (OV) compares to the requested output version (rOV) (see FIGS. 1, 6, 7, and corresponding text for further details regarding translator selection). Mediator 220 invokes translator 240, and passes the provided input data value to translator 240. Translator 240 translates the provided input data value, and returns a translated data value to mediator 220. Mediator 220 constructs a property (i.e. “Property Z”) using the translated data value and component B 290's recipient input property type. Mediator 220 includes the constructed property in call 245, and sends call 245 to component B 250 for processing.

In one embodiment, mediator 220 and component B 250 may be on different servers than component A 100. In this embodiment, information exchange between component A 100, mediator 220, and component B 250 may be over a computer network, such as a LAN or the Internet.

FIG. 2B is a diagram showing a first component identifying a translator, translating a request using the translator, and calling a second component using the translated request. Component A 100 wishes to send a call to component B 250 and looks-up component B 250's input property type in component store 235. Component B 250's input property type defines a type and version corresponding to the data component B 250 wishes to receive.

Component A 100 identifies an input property type identifier corresponding to component B 250, and selects a translator located in translator store 140 using component B 250's requested input type and version (see FIGS. 1, 6, 7, and corresponding text for further details regarding translator selection). Translator store 140 is the same as that shown in FIG. 1. Component A 100 translates a data value using the selected translator (e.g. translator 240), and constructs a property using the translated data value and component B 250's recipient input property type. Component A 100 includes the constructed property in call 245, and sends call 245 to component B 250 for processing.

FIG. 3A is a structural representation of a translation request. Translation request 300 includes input property type 305, output property type 320, provided input data value 335, and a selection of compliant or “compliant and near compliant” translations. Input property type 305 includes input type 310 and provided input version 315 which correspond to the type and version of provided input data value 335, respectively.

Output property type 320 includes output type 325 and requested output version 330. Output type 325 informs a translation service as to what type to translate provided input data value 335. Requested output version 330 informs a translation service as to what version of the type to translate provided input data value 335.

Compliant only field 338 includes a value which indicates whether a translator service should only return translations that are version compliant. This value can additionally indicate that the translator service can relax its versioning restrictions because the requesting component is able to use earlier versions of the requested output data that are considered close or near to the requested version. A translation service uses input type 310, provided input version 315, output type 325, and requested output version 330 to select the most acceptable translator to translate provided input data value 335 (see FIGS. 6, 7, and corresponding text for further details regarding translator selection).

FIG. 3B is a translator look-up table that includes translators with various property types and property versions. Look-up table 340 includes five columns which are translator name column 345, input property version column 350, input property type column 355, output property type column 360, and output property version column 365.

Translator name column 345 includes names of translators that are available to translate component requests. Line 370 includes translator name “Temperature Fahrenheit to Celsius” and the corresponding translator may be used to translate a component request's data value that is in a semantic “Temperature” and units of measure “Fahrenheit” to a semantic “Temperature” and units of measure “Celsius”. Line 375 includes translator name “Measure Inches to Centimeters” and the corresponding translator may be used to translate a component request's data value that is in semantic “Length” and units of measure “inches” to semantic “Length” and units of measure “centimeters”. Line 380 includes translator name “Employee serial number to login id” and the corresponding translator may be used to translate a component request's data value that is in semantic “Employee” and units of measure “employee serial number” to a semantic of “Authentication” and a unit of measure “employee login id”.

Input property version column 350 includes a list of input property versions corresponding to translator names located in translator name column 345. Processing uses input property versions to assist in the selection of a translator. For example, look-up table 340 may include three translators, each with the name “Temperature Fahrenheit to Celsius”. In this example, as a portion of its translator selection process, processing identifies the translator with an input property version number that corresponds to the version of the data that the translator receives (i.e. provided input version) (see FIGS. 6, 7, and corresponding text for further details regarding translator selection).

Input property type column 355 includes input property type identifiers corresponding to each particular translator. Processing matches input property type identifiers with requester provided property type identifiers in the process of identifying translators corresponding to a particular request. Output property type column 360 includes output property type identifiers corresponding to each particular translator. Processing matches output property type identifiers with requested output property type identifiers in the process of identifying acceptable translators corresponding to a particular request. Processing uses output property versions to assist in the selection of a translator (see FIGS. 6, 7, and corresponding text for further details regarding translator selection).

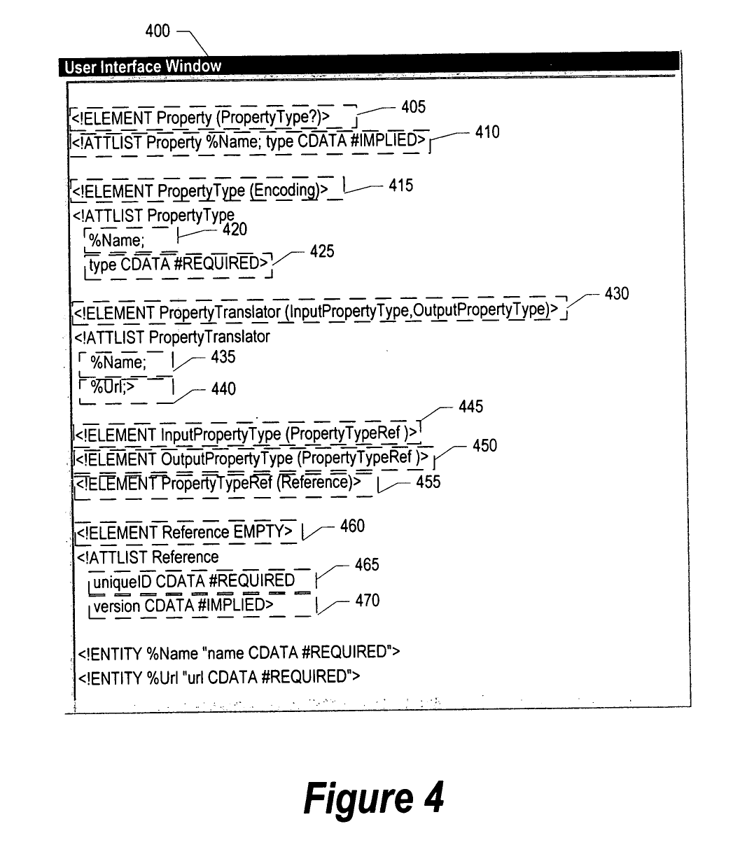

FIG. 4 is a user interface window, such as window 400, that includes various XML declarative statements. As one skilled in the art can appreciate, the declarative statements may be written in syntax other than XML. Line 405 includes a property element which describes a mechanism in which data is typed, inclusive of syntactic and semantic typing (property type). Line 410 includes the property's name (% Name) and an alternative method to type a property that does not include semantics (type) which may be used to retrofit existing systems that do not include semantic information.

Line 415 includes a property type element which describes a semantic encoding of a property as well as its syntactic typing. In essence, it forms a new typing system where semantic types and syntactic types are merged. Line 420 includes a name (% Name) which declares the name corresponding to the property type (i.e. a property type identifier). Line 425 includes a type which is scoped to the encoding and is dependent upon an encoding specification and is the actual type of the data value.

Line 430 includes a property translator element which describes a software entity that translates between two different property types. “InputPropertyType” is the input type specification for the translator and “OutputPropertyType” is the output type specification for the translator. Line 435 includes a name (% Name) which describes a name corresponding to the translator (i.e. a translator name). Line 440 includes a location corresponding to the translator.

Line 445 includes an input property type element which describes a property's type and version that is input to the translator. Line 450 includes an output property type element which describes an output property's type and version of the translator. Line 455 includes a property type reference element which describes a reference to a specific input property type or output property type for a specific component (component). Line 460 includes a reference element that describes a reference to a property type that includes a version and unique identifier. Lines 465 and 470 include the unique identifier and version that correspond to line 460, respectively.

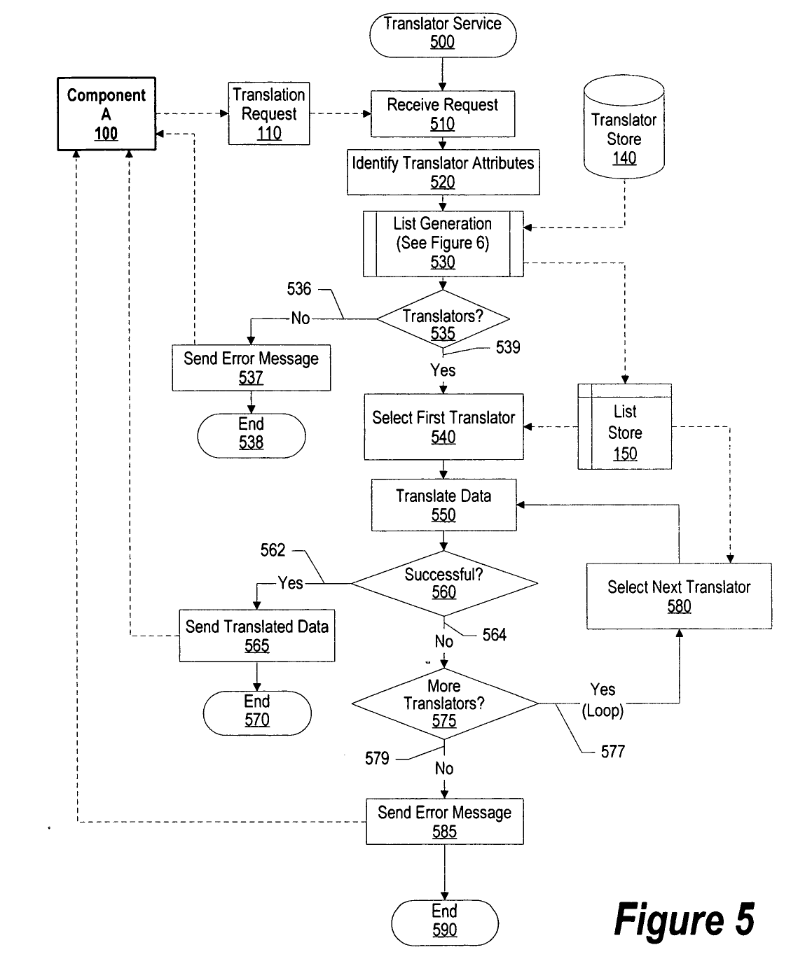

FIG. 5 is a flowchart showing steps taken in selecting a translator and using the translator to translate a component request. Processing commences at 500, whereupon processing receives translation request 110 from component A 100 (step 510). Component A 100 and translation request 110 are the same as that shown in FIG. 1. Processing extracts translator attributes from translation request 110 at step 520. The translator attributes include an input and output type, as well as input and output versions (see FIG. 3A and corresponding text for further details regarding translator attributes).

Processing identifies one or more acceptable translators located in translator store 140 using the provided input type and version and the requested output type and version. It then includes one or more translator identifiers that correspond to each acceptable translator in a translator list located in list store 150 (pre-defined process block 530, see FIG. 6 and corresponding text for further details). List store 150 and translator store 140 are the same as that shown in FIG. 1.

A determination is made as to whether processing identified one or more acceptable translators (decision 535). If processing did not identify at least one acceptable translator, decision 535 branches to “No” branch 536 whereupon processing sends an error message to component A 100 (step 537), and ends at 538. On the other hand, if processing identifies at least one acceptable translator, decision 535 branches to “Yes” branch 539.

Processing selects a first acceptable translator corresponding to the first translator identifier located in list store 150 at step 540. Processing then translates the provided input data value included in translation request 110 using the first acceptable translator. A determination is made as to whether the translation is successful using the first acceptable translator (decision 560). If the translation is successful, decision 560 branches to “Yes” branch 562 whereupon processing sends the translated data to component A 100, and processing ends at 570.

On the other hand, if the translation was not successful, decision 560 branches to “No” branch 564 whereupon a determination is made as to whether there are more translator identifiers in list store 150 that correspond to acceptable translators (decision 575) If there are more translator identifiers that correspond to acceptable translators, decision 575 branches to “Yes” branch which loops back to select (step 580) and process a second acceptable translator. This looping continues until there are no more acceptable translators to use to translate the provided input data value, at which point decision 575 branches to “No” branch 579 whereupon processing sends an error message to component A 100 indicating that the translation service is not able to perform its translation request. Processing ends at 590.

In one embodiment, after receiving an error message from a translation service, component A 100 may choose to send a second translation request to the translation service which has more relaxed requirements, such as requesting a translator whose version nearly matches an input or output version (i.e. near compliant) (see FIGS. 6, 7, and corresponding text for further details regarding compliant and near compliant version matching).

FIG. 6 is a flowchart showing steps taken in generating a translator list using a provided input type and version and requested output type and version that correspond to a translation request (see FIG. 3A and corresponding text for further details regarding translation request properties). Processing commences at 600, whereupon processing selects a master list of translators whereby the input data type on a translator matches the input data type of a request, and the output data type on the translator matches the output data type on the request.

Processing then identifies one or more of the type matched translators located in translator store 140 whose input version (IV) matches the provided input version (pIV) and whose output version (OV) matches the requested output version (rOV) (step 610). For each identified translator, processing adds a translator identifier in list store 150. Translator store 140 and list store 150 are the same as that shown in FIG. 1.

Processing proceeds to identify other compliant type matched translators at step 620 whereby processing identifies one or more translators located in translator store 140 whose input version (IV) matches the provided input version (pIV) and whose output version (OV) is greater than the requested output version (rOV) (see FIG. 7 and corresponding text for further details regarding translator selection criteria). For each identified translator, processing adds a translator identifier in the translator list after the existing translator identifiers.

Processing then identifies one or more type matched translators located in translator store 140 whose input version (IV) is less than the provided input version (pIV) and whose output version (OV) matches the requested output version (rOV) (step 630). For each identified translator, processing adds a translator identifier in the translator list after the existing translator identifiers.

Processing proceeds to identify more compliant type matched translators at step 640 whereby processing identifies one or more translators located in translator store 140 whose input version (IV) is less than the provided input version (pIV) and whose output version (OV) is greater than the requested output version (rOV) For each identified translator, processing adds a translator identifier in the translator list after the existing translator identifiers.

A determination is made as to whether processing should check for near compliant translators (decision 650). A translation request includes a field which indicates whether a component accepts near compliant translations (see FIG. 3A and corresponding text for further details regarding translation request properties). If the component requests only a compliant match, processing is finished identifying translators and decision 650 branches to “No” branch 652 whereupon processing returns at 655. On the other hand, if the component accepts a near compliant match, decision 650 branches to “Yes” branch 658.

Processing proceeds to identify near compliant match translators using near compliance selection criteria (see FIG. 7 and corresponding text for further details regarding near compliant selection criteria). Processing identifies one or more type matched translators located in translator store 140 whose input version (IV) matches the provided input version (pIV) and whose output version (OV) is less than the requested output version (rOV) (step 660). For each identified translator, processing adds a translator identifier in the translator list after the existing translator identifiers.

Processing then identifies near compliance type matched translators located in translator store 140 whose input version (IV) is less than the provided input version (pIV) and whose output version (OV) is less than the requested output version (rOV) (step 670). For each identified translator, processing adds a translator identifier in the translator list after the existing translator identifiers. Processing returns at 680.

In one embodiment, a translator that does not meet one of the selection criteria as discussed above may be considered incompatible in which case the translator is not considered for selection, such as when a translator's input version is greater than the provided input version.

FIG. 7 is a translation selection criteria table showing an order in which a translation service selects translators based upon input and output data versions. A translator service first selects a master list of translators whereby the input data type on a translator matches the input data type of a request, and the output data type on the translator matches the output data type on the request. This list is then subject to the selection criteria shown in FIG. 7.

Chart 700 includes columns 710 through 740. Column 710 includes a list of comparison results when comparing a translator's input version (IV) with a translation requests provided input property version (pIV). For example, if a translator's IV is equal to the pIV included in a translation request, IV equals pIV which meets the selection criteria in rows 750, 760, and 790. Column 720 includes a list of comparison results when comparing a translator's output version (OV) with a translation requests requested output property version (rOV). For example, if a translator's OV is greater than the rOV included in a translation request, OV is greater than rOV which meets the selection criteria in rows 760 and 780.

Column 730 includes an order selection list for criteria shown in columns 710 and 720 when a component requests a compliant match. Column 730 shows that translators whose IV matches pIV and whose OV matches rOV are selected “First” and corresponding translator identifiers are placed in a translator list. Translators whose IV matches pIV and whose OV is greater than rOV are selected “Second” and corresponding translator identifiers are placed in a translator list after the translators that are selected first. Translators whose IV is less than pIV and whose OV equals rOV are selected “Third” and corresponding translator identifiers are placed in a translator list after the translators that are selected second. And, translators whose IV is less than pIV and whose OV is greater than rOV are selected “Fourth” and corresponding translator identifiers are placed in a translator list after the translators that are selected third.

Column 740 includes an order selection list for criteria shown in columns 710 and 720 when a component requests compliant and near compliant matches. Column 740 is identical to column 730 with the addition of two near match selection criteria. Column 740 includes translator selection whose IV equals pIV and whose OV is less than rOV, which are selected “Fifth” and corresponding translator identifiers are placed in a translator list after the translators that are selected forth. And, translators whose IV is less than pIV and whose OV is less than rOV are selected “Sixth” and corresponding translator identifiers are placed in a translator list after the translators that are selected fifth. Translators that do not adhere to one of the criteria in table 700 are considered incompatible to translate data for a particular translation request.

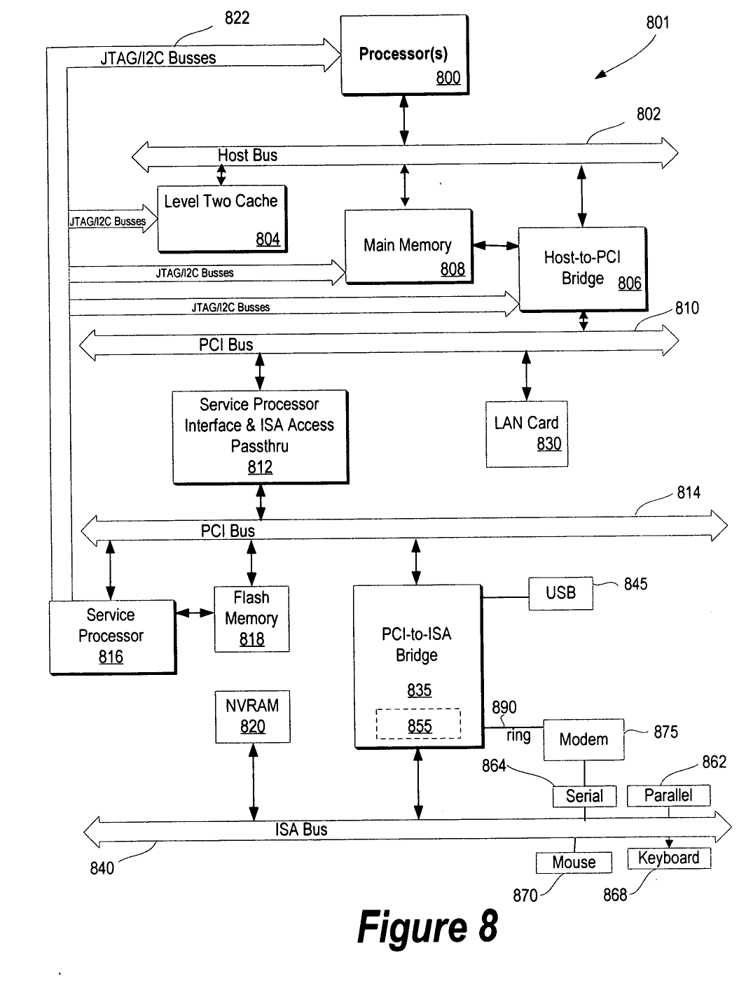

FIG. 8 illustrates information handling system 801 which is a simplified example of a computer system capable of performing the computing operations described herein. Computer system 801 includes processor 800 which is coupled to host bus 802. A level two (L2) cache memory 804 is also coupled to host bus 802. Host-to-PCI bridge 806 is coupled to main memory 808, includes cache memory and main memory control functions, and provides bus control to handle transfers among PCI bus 810, processor 800, L2 cache 804, main memory 808, and host bus 802. Main memory 808 is coupled to Host-to-PCI bridge 806 as well as host bus 802. Devices used solely by host processor(s) 800, such as LAN card 830, are coupled to PCI bus 810. Service Processor Interface and ISA Access Pass-through 812 provides an interface between PCI bus 810 and PCI bus 814. In this manner, PCI bus 814 is insulated from PCI bus 810. Devices, such as flash memory 818, are coupled to PCI bus 814. In one implementation, flash memory 818 includes BIOS code that incorporates the necessary processor executable code for a variety of low-level system functions and system boot functions.

PCI bus 814 provides an interface for a variety of devices that are shared by host processor(s) 800 and Service Processor 816 including, for example, flash memory 818. PCI-to-ISA bridge 835 provides bus control to handle transfers between PCI bus 814 and ISA bus 840, universal serial bus (USB) functionality 845, power management functionality 855, and can include other functional elements not shown, such as a real-time clock (RTC), DMA control, interrupt support, and system management bus support. Nonvolatile RAM 820 is attached to ISA Bus 840. Service Processor 816 includes JTAG and I2C busses 822 for communication with processor(s) 800 during initialization steps. JTAG/I2C busses 822 are also coupled to L2 cache 804, Host-to-PCI bridge 806, and main memory 808 providing a communications path between the processor, the Service Processor, the L2 cache, the Host-to-PCI bridge, and the main memory. Service Processor 816 also has access to system power resources for powering down information handling device 801.

Peripheral devices and input/output (I/O) devices can be attached to various interfaces (e.g., parallel interface 862, serial interface 864, keyboard interface 868, and mouse interface 870 coupled to ISA bus 840. Alternatively, many I/O devices can be accommodated by a super I/O controller (not shown) attached to ISA bus 840.

In order to attach computer system 801 to another computer system to copy files over a network, LAN card 830 is coupled to PCI bus 810. Similarly, to connect computer system 801 to an ISP to connect to the Internet using a telephone line connection, modem 875 is connected to serial port 864 and PCI-to-ISA Bridge 835.

While the computer system described in FIG. 8 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method comprising:
receiving a translation request, the translation request including a provided input version and a requested output version;
comparing the provided input version to one or more translator input versions and comparing the requested output version to one or more translator output versions, the comparing resulting in a comparison result;
selecting a first translator from a plurality of translators based upon the comparison result; and
translating data using the first translator.

2. The method of claim 1 further comprising:
accessing a translator selection criteria table, the translator selection criteria table including a plurality of selection criteria;
identifying a first selection criteria from the plurality of selection criteria;
matching the comparison result with the first selection criteria; and
including a first translator identifier in a translator list corresponding to the first translator based upon the matching.

3. The method of claim 2 further comprising:
identifying a second selection criteria from the plurality of selection criteria;
matching the comparison result with the second selection criteria; and
including a second translator identifier in the translator list after the first translator, the second translator identifier corresponding to a second translator.

4. The method of claim 2 further comprising:
determining whether to use near compliant selection criteria included in the translation table;
identifying one or more near compliant translators using the near compliant selection criteria based upon the determination; and
including one or more translator identifiers in the translator list that correspond to the near compliant translators.

5. The method of claim 1 further comprising:
determining whether the translating was successful; and
selecting a second translator to translate the data in response to the determination.

6. The method of claim 1 wherein the translation is performed using a translator system, and wherein the translator system is selected from the group consisting of a component, a mediator, and a translator service.

7. The method of claim 1 wherein the translation request includes an input type and an output type, and wherein the plurality of translators correspond to the input type and the output type.

8. An information handling system comprising:
one or more processors;
a memory accessible by the processors;
one or more nonvolatile storage devices accessible by the processors; and
a translation tool for translating data, the translation tool comprising software code effective to:
receive a translation request, the translation request including a provided input version and a requested output version;
compare the provided input version to one or more translator input versions located in one of the nonvolatile storage devices and comparing the requested output version to one or more translator output versions located in one of the nonvolatile storage devices, the comparing resulting in a comparison result;
select a first translator from a plurality of translators located in one of the nonvolatile storage devices based upon the comparison result; and
translate the data using the first translator.

9. The information handling system of claim 8 wherein the software code is further effective to:
access a translator selection criteria table located in one of the nonvolatile storage devices, the translator selection criteria table including a plurality of selection criteria;
identify a first selection criteria from the plurality of selection criteria;
match the comparison result with the first selection criteria; and
include a first translator identifier in a translator list located in one of the nonvolatile storage devices corresponding to the first translator based upon the matching.

10. The information handling system of claim 9 wherein the software code is further effective to: identify a second selection criteria from the plurality of selection criteria;
match the comparison result with the second selection criteria; and
include a second translator identifier in the translator list located in one of the nonvolatile storage devices after the first translator, the second translator identifier corresponding to a second translator.

11. The information handling system of claim 9 wherein the software code is further effective to: determine whether to use near compliant selection criteria included in the translation table;
identify one or more near compliant translators located in one of the nonvolatile storage devices using the near compliant selection criteria based upon the determination; and
include one or more translator identifiers in the translator list that correspond to the near compliant translators.

12. The information handling system of claim 8 wherein the translation is performed using a translator system, and wherein the translator system is selected from the group consisting of a component, a mediator, and a translator service.

13. The information handling system of claim 8 wherein the translation request includes an input type and an output type, and wherein the plurality of translators correspond to the input type and the output type.

14. A computer program product stored on a computer operable media for translating data, said computer program product comprising software code effective to:
receive a translation request, the translation request including a provided input version and a requested output version;
compare the provided input version to one or more translator input versions and comparing the requested output version to one or more translator output versions, the comparing resulting in a comparison result;
select a first translator from a plurality of translators based upon the comparison result; and
translate data using the first translator.

15. The computer program product of claim 14 wherein the software code is further effective to:
access a translator selection criteria table, the translator selection criteria table including a plurality of selection criteria;
identify a first selection criteria from the plurality of selection criteria;
match the comparison result with the first selection criteria; and
include a first translator identifier in a translator list corresponding to the first translator based upon the matching.

16. The computer program product of claim 15 wherein the software code is further effective to:
identify a second selection criteria from the plurality of selection criteria;
match the comparison result with the second selection criteria; and
include a second translator identifier in the translator list after the first translator, the second translator identifier corresponding to a second translator.

17. The computer program product of claim 15 wherein the software code is further effective to:
determine whether to use near compliant selection criteria included in the translation table;
identify one or more near compliant translators using the near compliant selection criteria based upon the determination; and
include one or more translator identifiers in the translator list that correspond to the near compliant translators.

18. The computer program product of claim 14 wherein the software code is further effective to:
determine whether the translating was successful; and
select a second translator to translate the data in response to the determination.

19. The computer program product of claim 14 wherein the translation is performed using a translator system, and wherein the translator system is selected from the group consisting of a component, a mediator, and a translator service.

20. The computer program product of claim 14 wherein the translation request includes an input type and an output type, and wherein the plurality of translators correspond to the input type and the output type.
